(19) United States
(12) Patent Application Publication
(10) Pub. No.: US 2015/0026075 A1
(43) Pub. Date: Jan. 22, 2015

(54) CONTROL OF CRM DATA BASED ON SPREADSHEET ACTIONS

(71) Applicant: Microsoft Corporation, Redmond, WA (US)

(72) Inventors: Ron Mondri, Bellevue, WA (US); Jih-Shiang Chang, Bellevue, WA (US); Jujhar Singh, Bellevue, WA (US)

(21) Appl. No.: 13/943,615

(22) Filed: Jul. 16, 2013

(51) Int. Cl. G06Q 10/10; G06Q 30/00; G06F 17/24

(52) U.S. Cl. CPC G06Q 10/10; G06F 17/246; G06Q 30/016; G06Q 10/107
USPC 705/304

(57) ABSTRACT

Technologies are generally provided for controlling customer relationship management (CRM) data through actions in a spreadsheet application. A spreadsheet application may be configured to enable CRM data to be imported from a CRM application and to enable the CRM data to be manipulated employing native spreadsheet capabilities. A CRM application pane may be displayed within the spreadsheet application to enable data to be selected to be imported into the spreadsheet application. The CRM application pane may also display additional CRM information related to selected content displayed within the spreadsheet application. The CRM application pane may further enable collaborative functionalities such as communication with other users associated with the CRM application, taking notes and scheduling tasks, as some examples. Data changes made within the spreadsheet application may be saved and exported back to the CRM application.

### BACKGROUND

Customer Relationship Management (CRM) solutions provide tools and capabilities needed to create and maintain a clear picture of customers, from first contact through purchase and post-sales. For complex organizations, a CRM system may provide features and capabilities to help improve the way sales, marketing, and/or customer service organizations target new customers, manage marketing campaigns, and drive sales activities. CRM systems may include many components, hardware and software, utilized individually or in a shared manner by users internal or external to the organization.

CRM systems are an example of computing systems where data associated with entities such as persons, organizations, accounts, and similar ones are maintained for various purposes. Some of the information collected and maintained by CRM applications may also be collected by other common applications such as a communications and/or scheduling service (for example, Exchange Server A or Exchange Online A by Microsoft Corporation of Redmond, Wash.). Users may employ a spreadsheet application to manage and analyze data of CRM applications. Spreadsheet applications may be separate applications, and may require manual entry of CRM application data in order to perform data analysis, which may be time consuming and inefficient.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to integrating a spreadsheet application with a customer relationship management (CRM) application to enable control of CRM data through the spreadsheet application. A spreadsheet application may be configured to enable CRM data to be imported from a CRM application to enable the CRM data to be manipulated employing native spreadsheet capabilities and functionalities. Control elements associated with CRM data and functionality may be automatically provided on the spreadsheet application user interface. Manipulations of CRM data through those control elements may then be synchronized with the underlying CRM application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where spreadsheet applications may be integrated with CRM applications according to some embodiments;

FIGS. 2A and 2B illustrate integration of a CRM application with a spreadsheet application;

FIGS. 3A and 3B illustrate an example CRM application pane displaying CRM data related to content viewed in a spreadsheet application;

FIG. 4 illustrates an example CRM report generated via a spreadsheet application;

FIG. 5 is a networked environment, where a system according to embodiments may be implemented;

FIG. 6 is a block diagram of an example computing operating environment, where embodiments may be implemented;

FIG. 7 illustrates a logic flow diagram for process 800 of synchronizing CRM application data with a spreadsheet application according to embodiments.

### DETAILED DESCRIPTION

As briefly described above, a spreadsheet application may be bi-directionally integrated with a customer relationship management (CRM) application to enable CRM data to be manipulated through the spreadsheet application. A spreadsheet application may be configured to provide controls for manipulating CRM data and to enable collaborative functionalities such as communication with other users associated with the CRM application, taking notes and scheduling tasks, as some examples. Data changes made within the spreadsheet application may be saved and exported back to the CRM application.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, anon-volatile memory, a hard drive, a flash drive, a floppy disk, or a compact disk, and comparable media.

Throughout this specification, the term “platform” may be a combination of software and hardware components for providing CRM and/or email, contact, scheduling based services. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

The combined term spreadsheet application is used herein to collectively describe hosted and/or local applications that facilitate organization, analysis, and computation of data in tabular form, and similar services. A spreadsheet application may operate on data represented as cells of an array, organized in rows and columns, and each of the array is an element that can contain either numeric or text data, or the results of formulas that may automatically calculate and display a value based on the contents of other cells. An example of such applications is Excel® by Microsoft Corp. of Redmond, Wash. Such applications may provide one or more of the above listed functionality through a number of user interfaces. They may be executed on a server as a hosted service and accessed by users through thin clients such as browsers or locally executed client applications. Some of the services may be provided online, others may be provided offline. For simplicity, such applications are referred to collectively as spreadsheet applications.

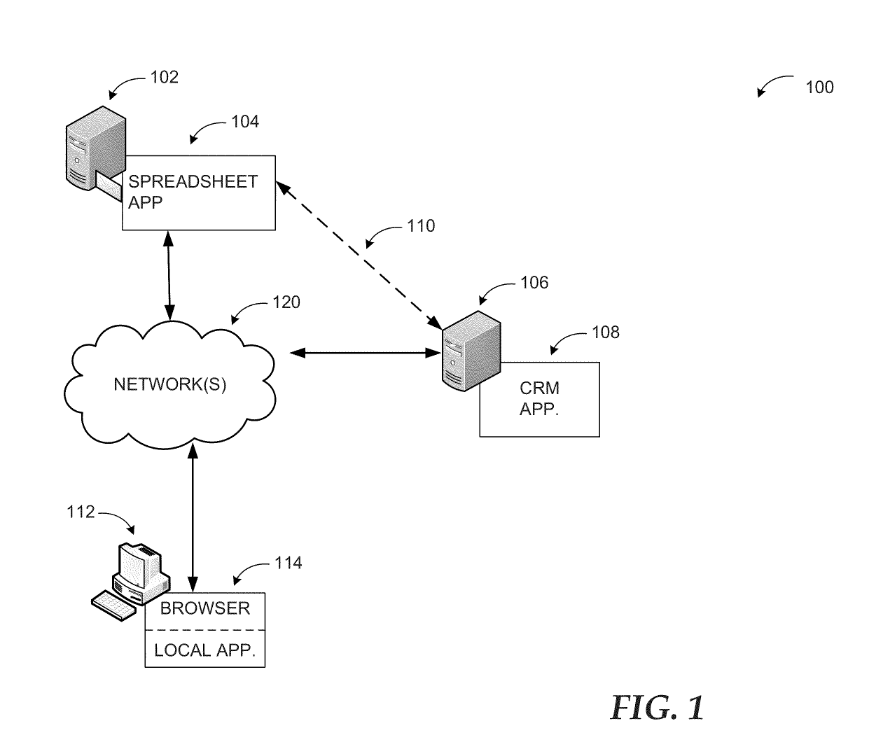

Referring to FIG. 1, diagram 100 illustrates a networked environment. where CRM applications and spreadsheet applications may be integrated, according to some embodiments. The computing devices and computing environments shown in diagram 100 are for illustration purposes. Embodiments may be implemented in various local, networked, and similar computing environments employing a variety of computing devices and systems.

In an example environment illustrated in diagram 100, a user may access a CRM application 108 executed on a CRM server 106 through a browser or client application 114 executed on the user's computing device 112 via network(s) 120. A CRM application/instance may enable a user to access data and functionality for different organizations. The user may also access data and other similar information from a spreadsheet application 104 executed on server 102 through the same or different browser or client application 114 executed on the user's computing device 112 via network(s) 120. Some of the tasks associated with the spreadsheet application 104 and the CRM application 108 may be performed online, while others may be performed offline. In case of dedicated client applications, the client application is sometimes referred to as offline client when it is operating without a connection to the spreadsheet application 104 and the CRM application 108. When the client application is in contact with the spreadsheet application 104 and/or the CRM application 108, it may be referred to as online client.

In an example embodiment, the CRM application 108 may provide tools and capabilities to create, maintain, and organize a clear picture of customers, or business opportunities, from first contact through purchase and post-sales. For complex organizations, a CRM application 108 may also provide features and capabilities to help improve sales, marketing, and/or customer service. Through the CRM application 108, a user may manage customers or business opportunities and may view information and data related to the opportunity, including contacts, budgeting information, associated products, sales information and history, key people associated with the account, appointment/meeting information, email data, and other comparable data. The CRM application 108 may also provide charts, graphs, spreadsheets and tables to display key information and data related to the customers and opportunities and to enable data analysis.

In a system according to embodiments, the spreadsheet application 104 and the CRM application 108 may be integrated 110 to enable hi-directional functionality and communication such that access to at least some of the functionality and data of the CRM application may be provided through the spreadsheet application. Without this functionality, a user may have to open two separate applications and manually import, organize, and manage data to perform data analysis and other similar operations.

Computing devices 112 and 116 may be any computing device including, but not limited to, desktop computers, laptop computers, servers, handheld computers, vehicle mount computers, smart phones, and comparable devices.

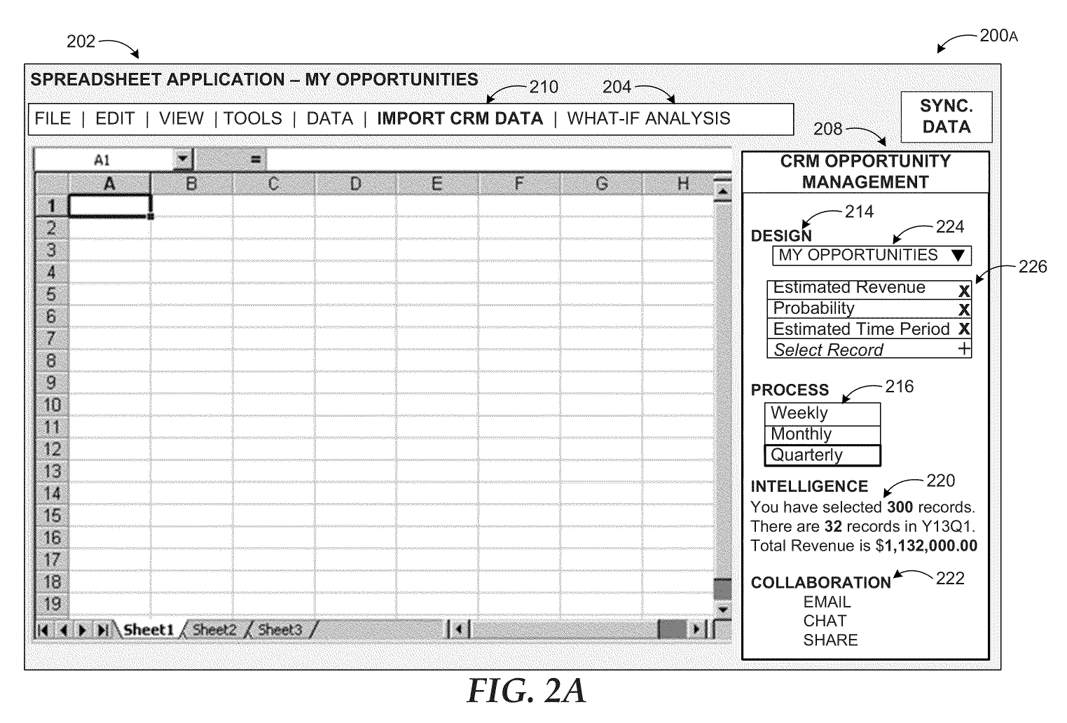

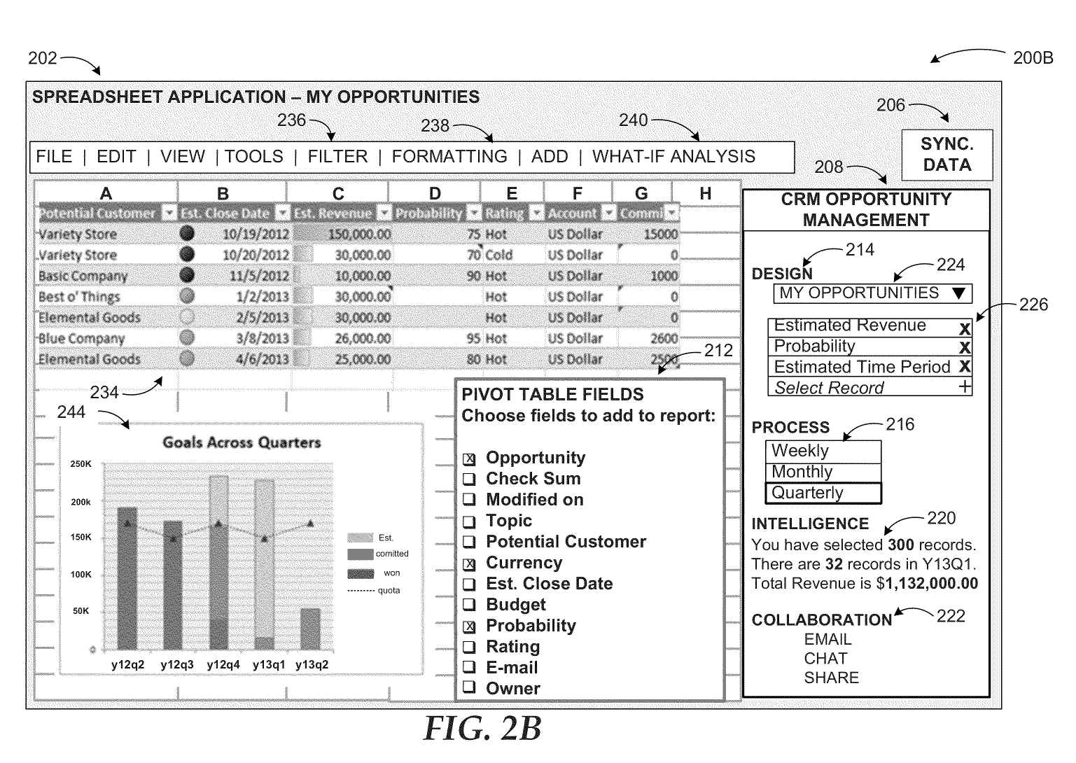

FIGS. 2A and 2B illustrate integration of a CRM application with a spreadsheet application, according to some embodiments. In a system according to embodiments, a CRM application and a spreadsheet application 202 may be integrated to enable bi-directional functionality and communication such that access to at least some of the functionality and data of the CRM application may be provided through the spreadsheet application 202.

A CRM application may provide tools and capabilities for managing a company's interactions with customers and business opportunities. Example tools and capabilities may facilitate organizing, automating, and synchronizing sales, performing marketing analyses, providing comprehensive customer service and technical support, and for maintaining a clear picture of customers, from first contact through purchase and post-sales. Throughout this specification, the term opportunity is used to collectively describe a potential sale or relationship with new or established customers.

In a system according to embodiments, a user, such as an accounts manager or sales person, may desire to analyze data associated with an opportunity in order to improve relations, productivity, and revenue associated with the customer and to predict financial situations. For example, the user may desire to create hypothetical scenarios, or “what-if” situations with the data by manipulating certain data and observing how data manipulations affect final numbers and goals. While certain data may be viewed in the CRM application, some data may be more readily manipulated employing spreadsheet application capabilities and functionalities.

As illustrated in diagram 200A, a spreadsheet application 202 may be opened on a user's computing device. The spreadsheet application 202 may be configured to enable CRM data from a CRM application to be imported into the spreadsheet application 202. An import CRM data option 210 may be displayed on a spreadsheet application toolbar 204, and upon selection of the import CRM data option 210, a CRM application pane 208 may be displayed within the spreadsheet application 202 to enable CRM data to be selected and imported into the spreadsheet application 202. An example CRM application pane 208 may include a design tab 214 configured to enable a user to select the CRM data to be imported into the spreadsheet application. The design tab 214 may provide a list of opportunities 224 that may be selected to import to the spreadsheet application 302.

Additionally, the CRM application pane 208 may also be configured to enable a type 226 of opportunity data to be selected for display in the spreadsheet application 202. Example opportunity data types may include estimated revenue, budget, rating, topic, contact information, probability, close dates, associated products, and other similar CRM data related to the opportunity. After selection of the opportunity data type to open in the spreadsheet application 202, a type of analysis 216 the user desires to perform may also be selected from the CRM application pane 208. For example, a lime period analysis such as a weekly or quarterly data review may be selected, or a comparison with historical data. Additionally, the user may select a data representation type such as a chart, table and/or graph to be displayed in the spreadsheet application 202. The above examples of data and analysis types are not intended to be limiting, but are exemplary of types of opportunity data and analyses that may be selected from the CRM application pane 208 to open and view in the spreadsheet application 202.

In another example embodiment, after selection of the data and type of data analysis from the CRM application pane 208, a table, chart, and/or graph may be displayed in the spreadsheet application 202, as illustrated in diagram 200B. The displayed table, chart and/or graph may be automatically populated with CRM data retrieved from the CRM application. In the case of a table 234, for example, the spreadsheet application may also present a table options pane 212, which may display additional data that may be selected to be imported into the spreadsheet application from the CRM application. Similarly, an options pane may presented with options related o a displayed chart 244 or graph within he spreadsheet application 202.

In a further embodiment, after the CRM data has been imported and displayed within the spreadsheet application 202, a user may select pre-set and conditional formatting 238 options native to the spreadsheet application to format displayed CRM data. Pre-set and conditional formatting 238 may include formatting options such as background color, borders, or font formatting to data values that meets certain defined conditions. Additionally, the spreadsheet application may enable different chart, table, and graph styles to be selected and applied to the displayed CRM data. Further, the spreadsheet application 202 may provide a filtering 236 capability to enable CRM data to be filtered within the spreadsheet application.

In yet another embodiment, the spreadsheet application 202 may he configured to provide a hypothetical analysis option 240, where a user may select the analysis option 240 in order to analyze a hypothetical or “what-if” scenario. When the hypothetical analysis option 240 option is selected, the user may change field values and evaluate how the changed values affect other related values. The user may also select to save the changed data as a tracked analysis at the CRM application in order to save a hypothetical scenario analysis for future use.

In a system according to embodiments, the CRM application and the spreadsheet application 202 may be continuously synchronized such that changes made to CRM data in the spreadsheet application 202 may be updated at the CRM application. The synchronization of data may he continuous, such that changes may he continuously updated at the CRM application. In other embodiments, the user may determine when to synchronize data from the spreadsheet application 202 with the CRM application, For example, during a hypothetical analysis, the data may not be synchronized until the user selects to synchronize and save the changed data at the CRM application. A synchronize data option 206 displayed at the spreadsheet application 202 may enable the user to select to synchronize the data with the CRM application.

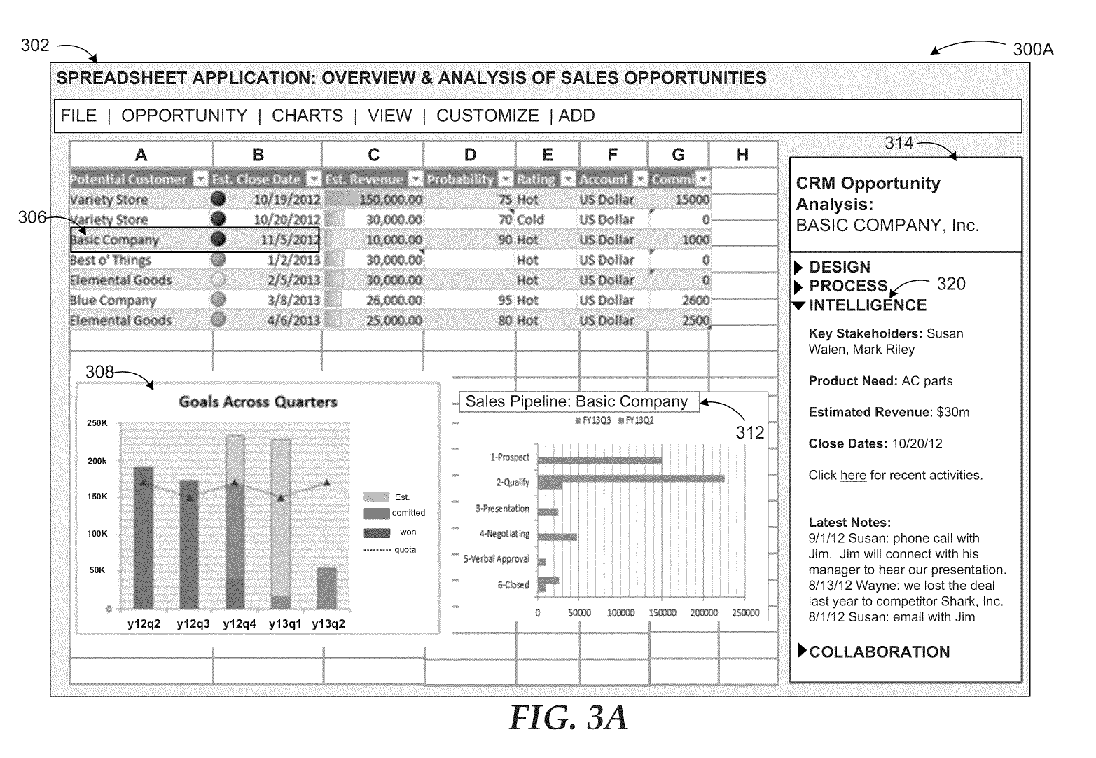

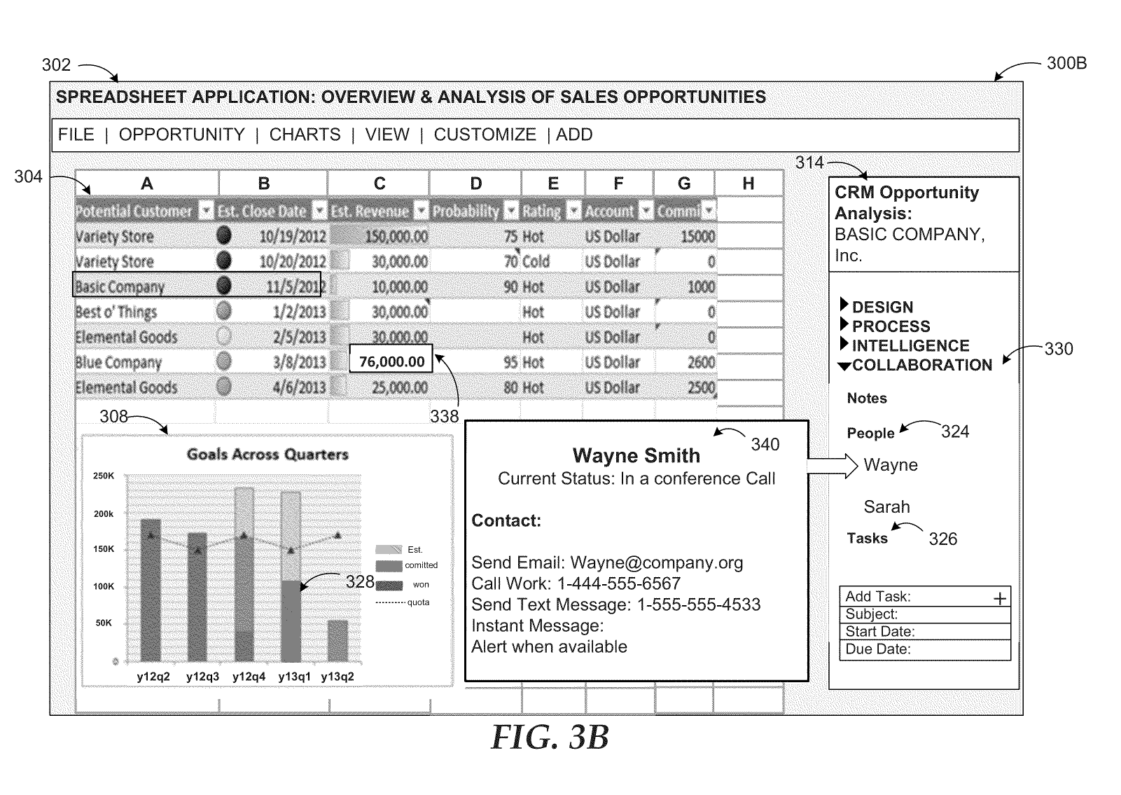

FIGS. 3A and 3B illustrate an example CRM application pane displaying CRM data related to content viewed in a spreadsheet application, according to some embodiments herein.

In a system according to embodiments, the spreadsheet application 302 and the CRM application may be continuously synchronized to provide comprehensive information related to an opportunity. A CRM application pane 314 may be displayed within the spreadsheet application 302 to provide additional CRM information and to enable CRM functionality with the displayed content. For example, a field 306 of a table 304 displayed at the spreadsheet application 202 may be selected, and information related to the field contents, such as an opportunity name, may be displayed in the CRM application pane 314. An information tab such as an intelligence 320, for example, may provide information such as summary information related to the opportunity contained in the selected field 306. Example summary information may include key stakeholders and key people, financial information such as total revenue or budget, important dates, product needs, notes, dates, and recent activities, and other similar information. The information displayed in the CRM application pane 314 may be customized to display a variety of selected CRM information based on user preferences. Additionally, if the user selects a different field containing a different opportunity or other CRM data, the CRM application pane 314 may automatically update to display CRM information related to the newly selected field.

In another example embodiment, as illustrated in diagram 300B, the CRM application pane 314 may also display collaboration 330 functionalities for enabling collaboration and communication between users associated with a CRM opportunity. Some example collaboration 330 functionalities may include enabling conversations to be initiated with other users associated with the CRM opportunity. For example, a list of key people 324 associated with the CRM opportunity may be displayed. A user may be selected from the displayed list of key people, and a collaboration pane 340 associated with the selected user may be displayed. The collaboration pane 340 may provide options to collaborate with the selected user such as options to send an email, make a call, send an instant message, schedule a meeting, and other similar communication options. Based on a selected communication option, a pane associated with the selected option, such as an email pane or instant message pane, for example, pane may be provided from within the spreadsheet application 302.

Furthermore, a tasks 326 tab may enable tasks associated with an opportunity to be assigned and created, such as, for example, scheduling a follow-up, creating reminders for assigned tasks, assigning tasks to users, and the like. The example CRM opportunity to information and functionalities included on the CRM application pane 314 are not intended to be limiting, but are exemplary of some example CRM functionalities that may be provided in conjunction with a spreadsheet application.

As also illustrated in diagram 300B, CRM data may be manipulated and changed within the spreadsheet application 302, and related CRM data may be automatically updated within the spreadsheet application 302. For example, a user may manually change a value of a field 338 in a displayed table 304, and the change in the field value may affect other field values or information within the spreadsheet application 302. In an example scenario, a displayed graph 308 may depend on values for one or more fields of the displayed table 304. When the user changes the field 338 value, the graph 308 may automatically be updated to reflect the new value. For example, the user may change an estimated revenue value from $26,000 in the field 338 to 576,000, and as a result of the value change, a portion 328 of the graph 308 corresponding to the value may increase to reflect the updated field 338 value.

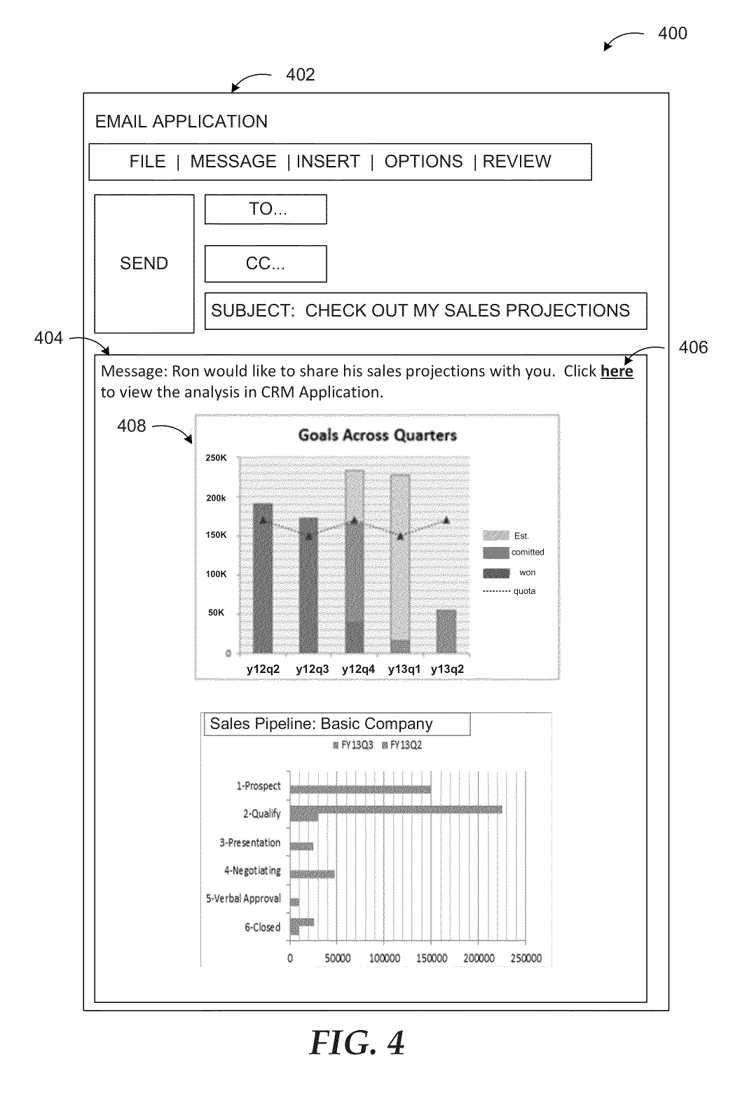

FIG. 4 illustrates an example CRM report generated via a spreadsheet application, according to some embodiments herein.

As illustrated in diagram 400, in an example embodiment, after manipulating and analyzing CRM data in the spreadsheet application as described above, a summary report 404 of the CRM data analysis may he generated in order to share the analysis with other users. The report 404 may be inserted within an email 402, and the user may select user to share the report 404 with. The report 404 may also include a link 406 to the data analysis in the spreadsheet and/or CRM application such that a viewer of the report may select the link 406 to automatically navigate to the opportunity analysis fir a more detailed view.

The examples in FIG. 2 through 4 have been described with specific configurations and components. Embodiments are not limited to systems according to these example configurations and components. Bidirectional integration between CRM applications and spreadsheet applications may be implemented in configurations using other types of components, processes, and configurations in a similar manner using the principles described herein.

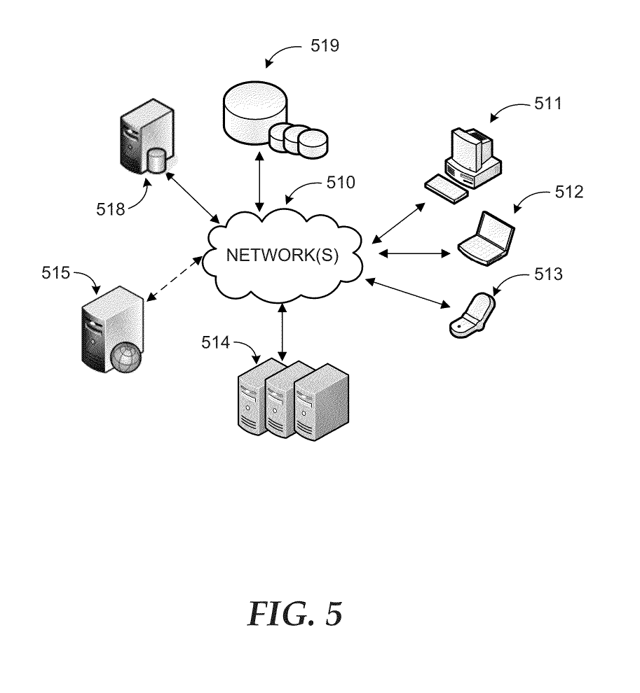

FIG. 5 is an example networked environment, where embodiments may be implemented. A system for bidirectional integration between CRM applications and spreadsheet applications may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may communicate with a spreadsheet application and a CRM application executed on one or more of servers 514. A synchronization module executed in conjunction with a spreadsheet application and a CRM application executed on server 515 may facilitate bidirectional synchronization of various forms of data maintained CRM application with the spreadsheet application as discussed previously. The CRM and/or spreadsheet application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RE, infrared and other wireless media.

Many other configurations of computing devices, applications, data sources, and data distribution systems may be employed to implement a platform providing bidirectional synchronization between spreadsheet and CRM applications. Furthermore, the networked environments discussed in FIG. 5 are for illustration purposes only. Embodiments are not limited to the example applications, modules, or processes.

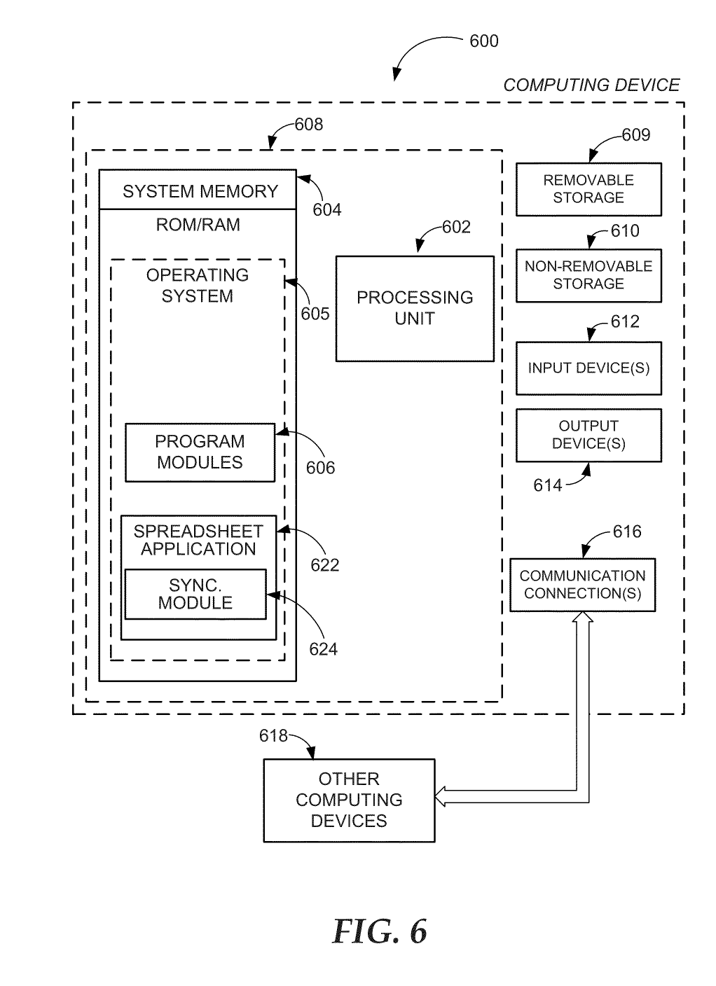

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application capable of providing a spreadsheet application and a GRIM application with access to CRM data according to embodiments, and may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from Microsoft Corporation of Redmond, Wash. The system memory 604 may also include one or more software applications such as program modules 606, spreadsheet application 622, and synchronization module 624.

A spreadsheet application 622 may provide functionalities and capabilities for manipulating and analyzing data in tabular, chart and graphic form. Synchronization module 624 may enable bidirectional synchronization of data such as opportunity data from a CRM application related to customers and business opportunities managed at the CRM application between the spreadsheet application 622 and the CRM application. The spreadsheet application 622, CRM application, and synchronization module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

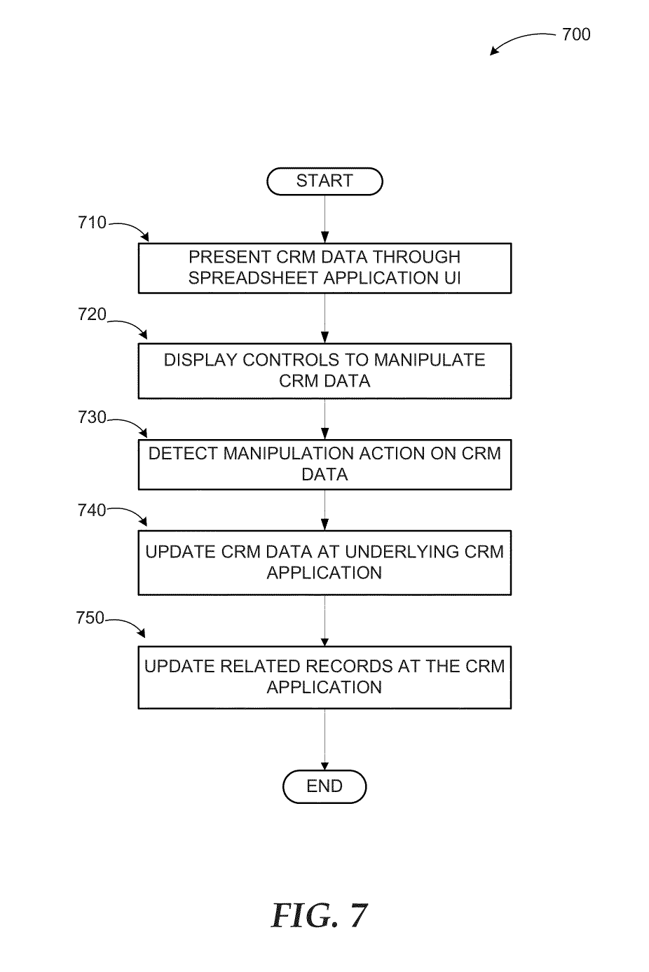

FIG. 7 illustrates a logic flow diagram for process 700 of synchronizing CRM application data with a spreadsheet application according to embodiments. Process 700 may be implemented on a server device.

Process 700 begins with operation 710, where a spreadsheet application may present CRM data from an underlying CRM application through its user interface. The spreadsheet application may be invoked from within the CRM application or vice versa. At operation 720, controls for manipulating the presented CRM data may be displayed by the spreadsheet application user interface, Upon detection of manipulation of the presented CRM data at operation 730, the CRM data may be updated at the underlying CRM application maintaining its transactional integrity. The transactional integrity may be preserved by, for example, updating records related to the CRM data through backend logic at the CRM application at operation 750.

According to other embodiments, a computing device such as a server may execute a CRM module in conjunction with the spreadsheet application that is configured to perform the above-described. operations. The CRM module may also present a CRM view pane while displaying a spreadsheet application user interface. The CRM module may also present one or more CRM functionalities in the CRM view pane and enable synchronization of changes to the underlying data bi-directionally between the spreadsheet application user interface and the CRM view pane. The CRM module may further enable initiation of an approval process, a communication session with a context of displayed data, and a real time communication session through the spreadsheet application user interface. Moreover, execution of a “What If” analysis may be enabled through the spreadsheet application user interface along with tracking of the analysis in the CRM application. The CRM application may be a hosted application and enable rolling up of spreadsheet data from multiple users based on a role of a user.

In further embodiments, a computer-readable memory device may include instructions stored thereon for integrating a spreadsheet application with a customer relationship management (CRM) application. The computer-readable memory device may include any physical data storage device remotely or locally accessible to a computing device executing those instructions. The instructions may further include presenting a CRM view pane while displaying a spreadsheet application user interface; displaying one or more of tabulated data, a chart, and a spreadsheet functionality control on the spreadsheet application user interface based on a selection of a presented item on the CRM view pane; and/or enabling one or more of chart generation, chart comparison, data aggregation, and information drill down on the spreadsheet application user interface.

The operations included in process 700 are for illustration purposes. Bidirectional integration between CRM applications and spreadsheet applications may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for controlling customer relationship management (CRM) data through actions in a spreadsheet application, the method comprising:
while presenting the CRM data through a user interface of the spreadsheet application, displaying one or more control elements associated with the CRM data;
in response to activation of one or more of the control elements, performing one or more operations on the CRM data through the spreadsheet application; and
updating the CRM data at an underlying CRM application based on the performed operations while maintaining a transactional integrity of the CRM data at the CRM application.

2. The method of claim 1, further comprising:
enabling selection of one or more of: an opportunity, a type of data, and a type of analysis to be manipulated at the spreadsheet application user interface, wherein the opportunity includes at least one of: an existing customer account and a potential customer account.

3. The method of claim 1, wherein performing one or more operations on the CRM data comprises enabling a computation within a cell of the spreadsheet presentation of the CRM data with the spreadsheet cell being bound to a CRM data value and the computation being performed based on a formula associated with the cell, the CRM data value, and a model represented in the spreadsheet application.

4. The method of claim 1, further comprising:
displaying one or more of: a chart, a table, and a graph related o the presented CRM data on the spreadsheet application user interface; and
creating one or more sheets of data comprising columns and rows, and creating one or more charts based on the data, wherein the data includes one or more of: contacts, financial information, products associated with the opportunity, sales information, sales history, and calendar information.

5. The method of claim 1, further comprising:
detecting selection of a field displayed on a table presented on the spreadsheet application user interface; and
providing CRM information and functionalities related to content contained in the selected field on the spreadsheet application user interface.

6. The method of claim 5, wherein displaying CRM information and functionalities related to content contained in the selected field comprises:
providing summary information associated with content contained in the selected field, wherein the summary information includes one or more of: key people, financial information including budget and revenue, products associated with the opportunity, dates, and recent activities.

7. The method of claim 5, wherein displaying CRM information and functionalities related to content contained in the selected field comprises:
providing collaborative functionalities associated with the content contained in the selected field, wherein the collaborative functionalities include one or more of: sharing CRM information with one or more other users, initiating communication with one or more other users, wherein the initiated communication includes one or more of: sending an email, initiating an audio call, sending an instant message, sending a text message, and scheduling a meeting.

8. The method of claim 7, wherein initiating communication with one or More other users further comprises:
displaying a pane associated with a selected user and a selected communication option on the spreadsheet application user interface.

9. The method of claim 5, wherein displaying CRM information and functionalities related to content contained in the selected field further comprises:
providing task functionalities associated with the content contained in the selected field, wherein the task functionalities include one or more of: creating tasks, assigning tasks, creating reminders, scheduling follow-ups, and taking notes.

10. The method of claim 1, further comprising:
detecting selection of a hypothetical analysis option;
detecting a change to one or more values displayed on a table presented on the spreadsheet application user interface; and
automatically saving the changed values as a tracked hypothetical analysis at CRM application.

11. The method of claim 1, further comprising:
detecting selection of a report generation option;
generating a summary report of a data analysis;
attaching the summary report to an email; and
providing a link to the data analysis in the CRM application to enable navigation to the data analysis from the email.

12. A computing device for controlling customer relationship management (CRM) data through actions in a spreadsheet application, the computing device comprising:
a memory;
a processor coupled to the memory, the processor executing a CRM module integrated within the spreadsheet application, the CRM module configured to:
while the CRM data is presented through a user interface of the spreadsheet application, display one or more control elements associated with the CRM data;
in response to activation of one or more of the control elements. perform one or more operations on the CRM data through the spreadsheet application;
enable customization of a one of a table, a graph, and a chart displayed on spreadsheet application user interface; and
update the CRM data at an underlying CRM application based on the performed operations while maintaining a transactional integrity of the CRM data at the CRM application.

13. The comps ting device of claim 12, wherein the CRM module is further configured to:
enable manipulation of the CRM data based on selection of one or more of: an opportunity, a type of data. and a type of analysis presented on the spreadsheet application user interface, wherein the opportunity includes at least one of: an existing customer account and a potential customer account, the type of data includes one or more of: estimated revenue, budget, rating, topic, contact information, probability, close dates, and products associated with the selected opportunity, and the type of analysis includes at least one of: a time period review and a comparison with historical data.

14. The computing device of claim 12, wherein the CRM module is further configured to:
detect selection of a field displayed on a table presented on the spreadsheet application user interface; and
provide CRM information and functionalities related to content contained in the selected field on the spreadsheet application user interface.

15. The computing device of claim 14, wherein the CRM module is further configured to:
provide summary information associated with the content contained in the selected field, wherein the summary information includes one or more of: key people, financial information including budget and revenue, products associated with the opportunity, dates, and recent activities;
provide collaborative functionalities associated with the content contained in the selected field, wherein the collaborative functionalities include one or more of: sharing CRM information with one or more other users, initiating communication with one or more other users, wherein the initiated communication includes one or more of: sending an email, making a telephone call, sending an instant message, sending a text message, and scheduling a meeting; and
provide task functionalities associated with the content contained in the selected field, wherein the task functionalities include one or more of: creating tasks, assigning tasks, creating reminders, scheduling follow-ups, and taking notes.

16. The computing device of claim 12, wherein the CRM module is further configured to:
enable execution of a “What If” analysis through the spreadsheet application user interface; and
enable tracking of the analysis in the CRM application.

17. A computer-readable memory device with instructions stored thereon for controlling customer relationship management (CRM) data through actions in a spreadsheet application, the instructions comprising:
while presenting the CRM data through a user interface of the spreadsheet application, displaying one of more control elements associated with the CRM data;
in response to activation of one or more of the control elements, performing one or more operations on the CRM data through the spreadsheet application;
enabling a computation within a cell of the spreadsheet presentation of the CRM data, wherein the spreadsheet cell is bound to a CRM data value and the computation is performed based on a formula associated with the cell, the CRM data value, and a model represented in the spreadsheet application; and
updating the CRM data at an underlying CRM application based on the performed operations while maintaining a transactional integrity of the CRM data at the CRM application.

18. The computer-readable memory device of claim 17, wherein the instructions further comprise:
detecting selection on the CRM pane of one or more of: an opportunity, a type of data, and a type of analysis presented on the spreadsheet application user interface, wherein the opportunity includes at least one of: an existing customer account and a potential customer account; and
upon detection of the selection of a field displayed on a table presented on the spreadsheet application user interface, providing CRM information and functionalities related to content contained in the selected field within the CRM pane, wherein the CRM information and functionalities include at least one of summary information, collaboration functionalities, and task functionalities.

19. The computer-readable memory device of claim 18, wherein the instructions further comprise:
enabling one or more of chart generation, chart comparison, data aggregation, and information drill down on the spreadsheet application user interface.

20. The computer-readable memory device of claim 17, wherein the instructions further comprising:
enabling one or more of initiation of an approval process, a communication session with a context of displayed data, and a real time communication session through the spreadsheet application user interface.
